(19) United States
(12) Patent Application Publication
(10) Pub. No.: US 2018/0230791 A1
(43) Pub. Date: Aug. 16, 2018

(54) Processes for economically recovering dissolved gas from deep aquifers and treating saline waters for culinary and/or irrigation.

(71) Applicant: Gary Farnsworth Player, Cedar City, UT (US)

(72) Inventor: Gary Farnsworth Player, Cedar City, UT (US)

(21) Appl. No.: 15/429,476

(22) Filed: Feb. 10, 2017

(51) Int. Cl. E21B 43/40; C02F 1/20; C10L 3/10; E21B 43/12; E21B 43/38

(52) U.S. Cl. CPC E21B 43/40; C02F 1/20; C02F 2101/322; E21B 43/121; E21B 43/38; C10L 3/106

(57) ABSTRACT

Natural gas dissolved in saline ground water can be recovered for use. The process includes the pumping of water production wells, separation of gas and water at the surface, gas compression, desalination of ground water, and injection of excess water into disposal wells. A definitive test of the process was completed on Jan. 9 and 10, 2013, at Gill Ranch Gas Field, California: volumes of recovered gas were equal to predictions based on methane solubility. Analyses of the gas showed that it was equal in heat value (about 975 BTU per cubic foot) to dry gas produced from the same field. Saline water recovered during the full scale test was returned to the same aquifer from which it was produced.

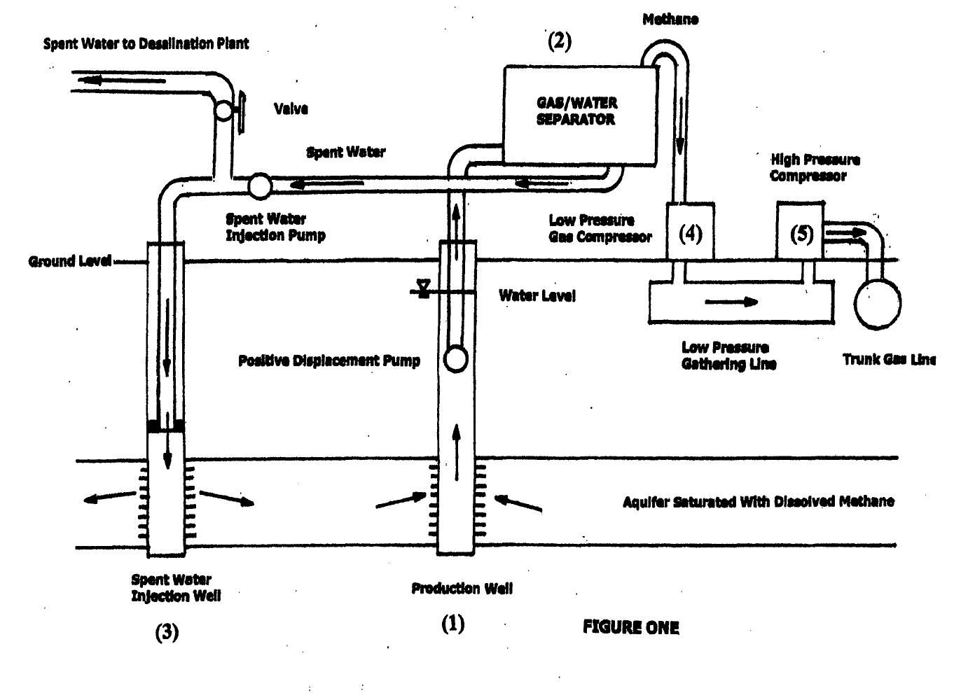

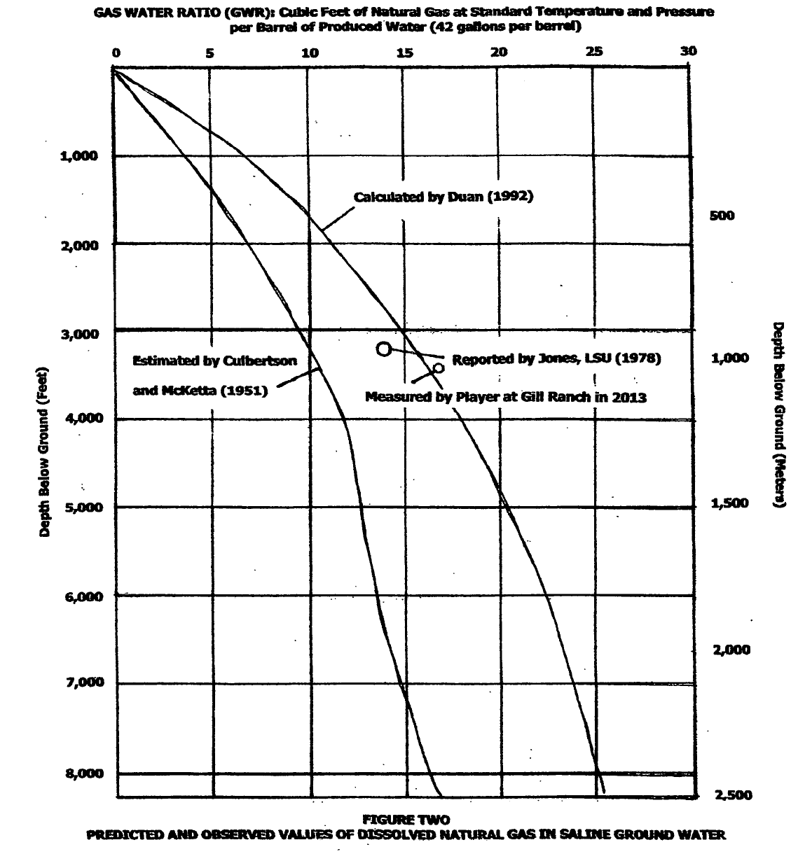

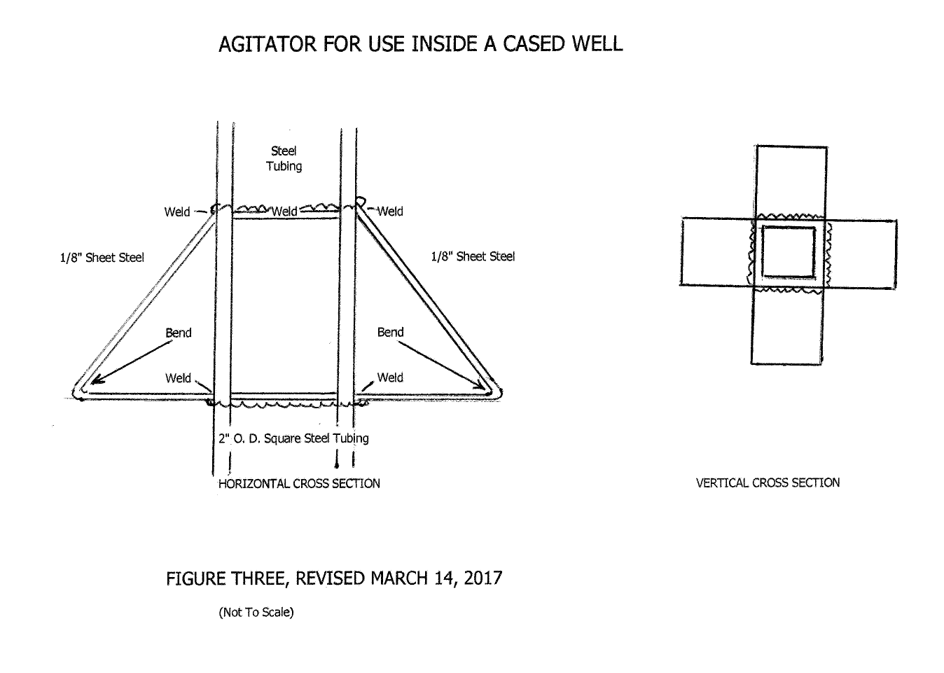

### RELATED U.S. PATENT DOCUMENTS

This invention contains new matter that modifies and clarifies previously rejected non provisional applications Ser. Nos. 12/806,528 and 13/694,411. An associated provisional patent application 62/389,306 was submitted on Feb. 18, 2016, with a filing or 371c date of Feb. 23, 2016.

### REFERENCES CITED

### Published References

Culbertson, O. L., and McKetta, J. J., Jr., (1951). “Phase equilibria in hydrocarbon-water systems III—the solubility of methane in water at pressures to 10,000 psia”: Petroleum Transactions of the American Institute of Mining Engineers, Vol. 192, p. 23-226.

Duan, Zhwenhao; Moller, Nancy; Greenberg, Jerry; and Weare, John H. (1992). “The prediction of methane solubility in natural waters to high ionic strength from 0 to 250 degrees C. and from 0 to 1600 bar,” Geochimica et Cosmochimica Acta, Vol. 56, Issue 4, pp. 1451-1460.

Jones, Paul H. (1969). “Hydrodynamics of Geopressure in the Northern Gulf of Mexico Basin,” Journal of Petroleum Technology, pp. 803-810, July 1969.

Marsden, S. S. and Kawai, K. (1965). “Suiyoscitennengasu—A special type of Japanese natural gas deposit,” American Association of Petroleum Geologists Bulletin, Vol. 49, No. 3, pp. 286-295.

### FEDERALLY SPONSORED RESEARCH OR DEVELOPMENT

Research or development associated with this invention is not sponsored by the Federal government.

### NAMES OF PARTIES TO A JOINT RESEARCH AGREEMENT

There are no parties associated with Gary F. Player that have a joint research agreement with Gary F. Player.

### SEQUENCE LISTING(S)

No sequence listings, tables, or computer programs have been submitted on compact discs. There are zero (0) compact discs submitted with this Patent Application.

### PRIOR DISCLOSURES BY THE INVENTOR

American Association of Petroleum Geologists Convention, Apr. 3, 2007; Oral Presentation Paper entitled “Economic Production of Sand Bed Methane from Ground Water,” by Gary F. Player.

American Association of Petroleum Geologists EXPLORER, November 2015; “Producing Dissolved Methane from Ground Water,” by Louise M. Durham, Explorer Correspondent.

American Association of Petioleum Geologists Pacific Section Convention, May 22, 2017; Oral Presentation Paper entitled “Recovery of unconventional resources of dissolved gas from non-potable Kenai Group aquifers in Cook Inlet Basin, Alaska and California's Great Valley,” by Gary F. Player.

### BACKGROUND OF THE INVENTION

### Technical Field of the Invention

This invention presents new processes for enhanced fossil energy recovery and alleviation of water shortages.

### Background Art

Energy costs in the United States can be freed from the demands of the world petroleum marketplace. One undeveloped fuel is methane dissolved in saline ground water. This gas is present throughout the petrolifcrous sedimentary basins of the world, beginning just a few hundred meters below the surface of the ground.

One feature of the dissolved gas recovery process is the requirement to pump saline ground water to the surface prior to separation of dissolved gas. An original plan was to then return virtually all of the produced water to the same aquifer from which it was produced in order to guard against surface settlement. However, when the water is produced from deep, consolidated rock aquifers, settlement is unlikely. Much of the saline water can be treated economically (using a small portion of the associated dissolved gas for the energy source) and made available for culinary water and/or irrigation water in areas suffering from shortages of potable water.

### BRIEF SUMMARY OF THE INVENTION

This Patent Application describes an economical method combining modern technologies to harvest, store, and use dissolved gas and saline ground water in the United States. The process includes:

1. Wells that will be drilled to depths from approximately 1,000 to 5,000 meters (3,280.8 to 16,404 feet) below ground level into deep, saline, aquifers.

2. Low pressure, high capacity, pumps for lifting ground water from the wells and transporting it through pipes to treatment facilities.

3. Oilfield style gas/water separators for removing dissolved methane from the produced saline ground water at surface temperatures and pressures.

4. Disposal wells for receiving saline waste water recovered from the separators.

### BRIEF DESCRIPTION OF THE DRAWINGS

Figure One shows steps in the process developed to separate dissolved methane from ground water. Arrows in Figure One show the direction of travel of water and gas in the system. Ground water is produced from one or more saline aquifers saturated with dissolved methane in a production well (1) equipped with a positive displacement pump. The water is piped in a closed system into a gas/water separator (2) al, or slightly above, ground level. Once the dissolved gas exits the ground water at surface pressures, spent water exits the bottom of the separator and a portion of the water is pumped into the spent water disposal well (3) where it is returned to the saline aquifer(s). Separated methane flows out the top of the separator to a low pressure gas compressor (4). From there the gas is shipped in a low pressure gathering line to a high pressure compressor. Gas is then compressed by a high pressure compressor (5) and injected into a trunk gas line for transport to markets.

Figure Two is a chart plotting the likely range of gas/water ratios (GWRs) for gas dissolved in 0.9 molar NaCl ground water, versus the depth below ground level. The vertical scale of FIG. Two is depth below ground, with depth in feet shown on the left-hand vertical axis, and depth in meters shown on the right-hand vertical axis. The horizontal axis shows the quantity of natural gas at standard temperature and pressure (STP) in cubic feet per 42 gallon barrel of produced water. Two diagonal, curved lines present a range of predicted and observed values of dissolved natural gas in saline ground water. The line on the left shows estimated concentrations of gas in ground water published by Culbertson and McKetta in 1951. The line on the right shows measured concentrations of gas in water containing NaCl published by Duan and others in 1992. A circle below 3,000 feet shows the concentration of natural gas produced from a saline aquifer along the coast of the Gulf of Mexico in 1978 as reported by Paul Jones of Louisiana State University at a petroleum industry seminar attended by Player. The gas/water ratio observed during the 2013 dissolved gas production test at Gill Ranch, California, is shown as a circle at approximately 3,400 feet below ground level, corresponding to the predictions of Duan.

### DETAILED DESCRIPTION OF THE INVENTION

Production Wells(s)

One or more wells, each producing 500 gallons or more per minute of deep, methane saturated saline ground water, will be the source(s) of dissolved gas and water for transport into the separators. The number and capacity of the well(s) will be based on the production rate needed for available gas markets. The quantity of saline water recovered from deep aquifers diverted for desalination will be determined by the markets for treated culinary and/or irrigation water.

Pump(s)

High volume, low pressure, pumps will be installed in each well to extract at least 500 gallons per minute of deep, saline ground water. Where local hydrologic conditions permit, wells will be completed in areas where static water levels are relatively shallow. The well casing will act essentially like a straw, and the pumps will merely pump water off the top of each “straw.” Very little lifting capacity will be required for properly located production wells. For example, static water levels at wells completed in aquifers below 1,000 meters (3,281 feet) in the western San Joaquin Valley of California routinely stand in well casing within 200 feet of ground level.

As an alternative to positive displacement electrically powered pumps, high pressure gas from adjacent regional trunk gas lines may be piped into production wells through small diameter (approximately one inch) “tremie” pipes. High pressure gas would lift the dissolved gas and associated saline ground water to the surface for separation.

Separator(s)

Methane is virtually insoluble in water at surface temperatures and pressures. Deep saline ground water containing dissolved gas will be pumped into oilfield style atmospheric pressure gas/water separators. Methane will be piped out the top, and water will be drawn out the bottom and a portion of the water returned to the same saline aquifer(s) through injection wells.

Compressor(s)

Methane will be recovered from the separators at or near atmospheric pressure. The gas must then be compressed for transport. Likely gathering line pressures will be about five (5) atmospheres or less so that the lines can be built with low strength steels or plastic.

Pipeline(s)

Gathering lines may be constructed of ABS or PVC plastics or steel. The lines should be at least six (6) inches in diameter, so that large volumes of gas can be stored per given distance. Gathering line pressures will be low (see previous paragraph).

Compressors(s) For Injecting Produced Gas Into Regional Trunk Pipelines Most regional trunk lines receive gas at about 1,000 pounds per square inch (about 68 atmospheres). Gas delivered in low pressure gathering lines will be compressed as needed for injection into the high pressure trunk line(s) for shipment to markets.

Injection Well(s)

Once dissolved methane has been recovered from deep ground water, much of the “spent” water will be injected back into the same aquifer. This step is important for two reasons:

1. The water will be saline and disposal will be carefully regulated by Federal, state, and local agencies; and

2. Local hydrostatic pressures in the same saline aquifer will have been reduced by nearby dissolved gas production wells, thereby reducing the energy required to pump the water back into the ground.

Retained Water

Some of the produced water may be retained at the surface and treated economically for sale as irrigation or culinary water. Demand for the water may be strong in arid or occasionally drought stricken areas such as the San Joaquin Valley of California.

Concentrations of Dissolved Methane in Ground Water

The quantity of recoverable dissolved methane in ground water (at surface temperature and pressure) is expressed in units of volume of gas per volume of water. In the metric system, solubility is expressed in liters per liter (L/L). Corresponding standard United States oilfield units are cubic feet per 42 gallon barrel (cf/bbl). A concentration of 1 L/L is approximately equal to 5.52 cf/bbl (Marsden, 1965).

Solubility of methane in high pressure, high temperature, deep aquifers (sedimentary rocks saturated with saline ground water) is well documented. Bonham (1978) reported methane solubility in aquifers ranging from 10 cf/bbl at 1,000 meters below ground, to about 50 cf/bbl at 5,000 meters below ground. Paul Jones of Louisiana State University reported production of 14 cf/bbl of methane from ground water at 1,000 meters below the sea floor along the coast of the Gulf of Mexico. Rigorous laboratory investigations of the solubility of methane in waters of varying NaCl concentrations, temperatures, and pressures were published by Duan et. al. (1992).

Rates of Methane Production

With an assumed dissolved methane concentration of just 3 L/L, or 16.5 cubic feet per barrel at about 1,000 meters below ground level, a water production rate of 500 gallons per minute from one well would provide 283 thousand cubic feet (283 MCF) of gas per day. Production of 20,000 gallons of water per minute from a field of 40 wells would provide about 11.31 million cubic feet (mmcf) of gas per day, or 11,314 MCF per day. A field of 100 wells could produce 28.28 million cubic feet per day, or 28,286 MCF per day.

Gas water ratios of about 25 cubic feet per barrel arc present below 2,500 meters. Gas production from these greater depths at the given water rates would be on the order of 428 MCF per day per well, or 42.8 million cubic feet per day (42,857 MCF) from a field of 100 wells.

Dissolved Methane Resources

Dissolved methane is present in virtually every basin now known to produce oil and dry gas. A typical example is the Great Valley of California. About 10 trillion cubic feet of dry gas have been produced from the basin to date. Potential dissolved methane resources are much greater.

The Great Valley has an area of at least 20,000 square miles, or 12,800,000 acres. Thousands of drilled wells have shown that at least 3,000 net feet of permeable sands and sandstones are present from about 3,000 feet to 10,000 feet below ground level. That thickness of sands and sandstones throughout the basin with an average porosity of 30 percent, and an average gas/water ratio of 20 cubic feet per barrel (sec FIG. Two), provides an undeveloped dissolved methane resource (at Surface Temperature and Pressure) of nearly 1,800 TCF in one basin of one state:

Area=20,000 square miles×640=12,800,000 acres

Net Sand Thickness=3,000 feet

Porosity=30 percent, or 0.3

Water Volume=(12,800,000)×(3,000)×0.3=11,520,000,000 acre-feet

Water Volume=11,520,000,000×7,758 barrels/acre-foot=89,372,160,000,000 barrels

Gas/Water Ratio (GWR)=20 cubic feet per barrel at Standard Temperature and Pressure

Dissolved Gas Volume=20×Water Volume in barrels, or 1,787.4 Trillion Cubic Feet

That volume of undeveloped dissolved methane is 180 times the cumulative California Great Valley gas production in the last 150 years. Similar quantities of dissolved methane occur in petroliferous basins beneath large portions of the United States, awaiting development.

Full Scale Tests of the Dissolved Methane Production Process

The first full scale test of the process was completed on Jul. 7-8, 2010 at the Gill Ranch Gas Field in Madera County, California. Gas-bearing water was produced from sands in the Upper Miocene age Santa Margarita Formation through perforated casing from about 3,140′ to 3,170′ feet below ground level (BGL). Due to open hole (the “annulus”) behind the casing wall, water from that interval was diluted by water from sands as shallow as 690 feet BGL, but gas was successfully separated from the water and burned in a flare for 16 hours. Laboratory analyses of the gas showed that it was equal in heat value (about 940 to 975 BTU per cubic foot) to dry gas produced from deeper zones at Gill Ranch.

The presence of dissolved gas in the Gill 19× well was proven in July of 2010. However, the test did not provide an accurate measurement of the ratio of dissolved gas to water in the Santa Margarita Formation (SMF). In December of 2012, Gill 19× was recompleted to isolate shallower water sands from the SMF sands. Large quantities of cement in two stages were pumped into the annulus through the old perforations, and 160 feet of new perforations were opened from 3,270-3,380 feet below ground level (BGL) and from 3,400-3,450 feet BGL. Four perforations were shot in each foot, for a total of 640 new holes in the casing, each approximately ⅜″ in diameter. A top drive, “Moyno” style, positive displacement pump was set inside 2 and ⅞″ diameter tubing at a depth of 900 feet, after the static water level stabilized at about 150 feet BGL.

PPS Testing Services of Bakersfield, Calif. set up a separator and a test flare during the morning of Wednesday, Jan. 9, 2013, and the pump was started at 12:45 P.M. The initial water production rate of 20 gallons per minute (gpm) was gradually increased to 68 gpm in the first hour, and the rate eventually increased to about 80 gpm as thin layers of silt interbedded with the SMF sands were washed loose by the produced water: drawdown of water in the casing while pumping at the same rate gradually decreased overnight. Six, 500-barrel “Rain for Rent” tanks were filled to about 80 percent of capacity by the time the test was completed at 12:00 noon on Thursday, Jan. 10, 2013. The gas/water ratio was measured at about 17 cubic feet at STP per 42 gallon barrel of water, virtually identical to the predictions from laboratory measurements by Duan.

Water Levels in Wells

Water standing in vertical well casing will stabilize at the “static water level,” that surface at which the weight of the water is equal to the hydrostatic pressure of the aquifer at the point of water entry. For example, saline water produced from the Santa Margarita Formation at the Gill 19× well in the Gill Ranch Gas Field in Madera County, California, had a static water level of approximately 150 feet below ground level.

Water in the Gill 19× well was produced from about 3,450 feet below ground level. Therefore, the height of the water column was 3,450′-150′ (the static water level)=3,300 feet. A column of pure water of that height would exert a pressure of 1,429 pounds per square inch. The relative density of water increases by approximately 0.00091 for each 1,000 milligrams per liter of dissolved solids. Therefore, the relative density of Santa Margarita connate water with 41,000 milligrams per liter of total dissolved solids (TDS) would be about 1+(41)*(0.00091)=1.03731. With a relative density of 1.03731, the pressure at the base of the water column would be (1429)*(1.03731)=1,482 pounds per square inch, the pressure exerted by 3,300 feet of water with 41,000 mg/L TDS.

This same approach can be used to estimate water levels and pressures for other areas. For example, the water in the deeper Garzas sandstone aquifer of Late Cretaceous age at Gill Ranch has TDS on the order of 20,000 mg/L. Therefore, the density of the water should be about 1+(20)*(0.00091)=1.0182. Water in Garzas wells would be produced from about 5,000 feet below ground level. A pure water column of that height would exert a pressure of 2,165 pounds. With a relative density of 1.0182, the pressure at the base of the 20,000 mg/L water column would be (2,165)*(1.0182)=2,204 pounds per square inch, the pressure exerted by 5000 feet of water with 20,000 mg/L TDS. While this estimate is not guaranteed to be accurate, it is at least possible that the Garzas sands under artesian pressures caused by ground water recharge from the Pacific Coast Ranges could flow gas-charged water to a static water level at or near the surface.

### Flowing Wells

Sandstones of Late Cretaceous age at the Rio Vista gas field in Solano County, California, have flowed saline water to the surface from below 7,000 feet during drill stem tests. One well, the McCormack-Anderson 1-2, was drilled by Chevron, USA, in 1992 and plugged and abandoned in 1995. Casing (4½″ outer diameter, or O.D.) was set to 7,505 feet, with the top of the cement inside the casing at 7,404 feet, and the well was perforated and tested from 7,064 feet to 7,076 feet measured depth.

The well flowed formation water through 4¼″ casing to the surface in less than one hour. That rate of entry was for water entering through 48 total perforations across 12 feet at the top of a 140 feet thick bed of sandstone. Each foot of the casing, assuming an inner diameter (“I.D.”) of 4″ would contain 150.79 cubic inches of water. That is equivalent to (150.79/1728)=0.087 cubic feet, or (087/0.1337)=0.653 gallons per foot of casing. Seven thousand tour hundred and four feet of 4¼″ O.D. casing would hold (7,404×0.653)=4,834.8 gallons. That amount of water entered the well through the perforations and flowed to the surface in 58 minutes, at a rate of (4,834.8/58)=approximately 83 gallons per minute.

Gas-saturated water from 7,076 feet below ground contains about 24 cubic feet of dissolved methane at standard temperature and pressure per 42 gallon barrel of water. The rate of 83 gallons per minute is equal to (83/42)=1.976 barrels per minute, or 2,845.6 barrels per day. At that rate, the flowing well would bring (24)(2,845.6)=68.3 thousand cubic feet (MCF) of gas to the surface with no pumping expense. For comparison, wells pumped at a rate of 500 gallons per minute would produce 17,143 barrels of water per day, accompanied by 411.4 MCF per day of dissolved gas at STP.

Gary F. Player personally observed unmeasured quantities of gas-charged saline ground water flowing to the surface from 5,200 feet at a well tested in 1986 on the Kenai Peninsula, Ak.

The invention claimed is:

1)-12) (canceled)

13) A process for economically recovering dissolved natural hydrocarbon gases (principally methane) from saline waters present in deep aquifers.

14) A set of conventionally constructed oil field style production wells according to claim 13, drilled to sufficient depths as determined from pre-existing well records to recover gases dissolved in saline waters.

15) A process for concurrent production and economical desalination of otherwise undeveloped volumes of saline ground water for use in areas with limited supplies of culinary and/or irrigation waters.

16) A gas recovery system according to claim 13 for separating dissolved hydrocarbon (principally methane) gases at ground level from saline waters produced from deep aquifers.

17) Water handling systems according to claim 14 for producing gas-saturated saline waters from previously undeveloped aquifers.

18) Low temperature desalination equipment constructed by others according to claim 15 sufficient to produce commercial quantities of culinary and/or irrigation waters from saline ground waters.
